(19) United States
(12) Patent Application Publication
(10) Pub. No.: US 2006/0028706 A1
(43) Pub. Date: Feb. 9, 2006

(54) Polarizer device for generating a defined spatial distribution of polarization states

(75) Inventors: Michael Totzeck, Schwaebisch Gmuend (DE); Heiko Feldman, Schwaebisch Gmuend (DE); Toralf Gruner, Aalen-Hofen (DE); Karl-Heinz Schuster, Koenigsbronn (DE); Joern N. Greif-Wuestenbecker, Jena (DE); Ulrich Stroessner, Jena (DE); Thomas Scheruebl, Jena (DE); Wolfgang Harnisch, Lehesten (DE)

Correspondence Address: SUGHRUE MION, PLLC, 2100 PENNSYLVANIA AVENUE, N.W., SUITE 800, WASHINGTON, DC, 20037, US

(73) Assignee: CARL ZEISS SMT AG

(21) Appl. No.: 11/174,489

(22) Filed: Jul. 6, 2005

Related U.S. Application Data
(60) Provisional application No. 60/585,842, filed on Jul. 8, 2004.

(51) Int. Cl. G02B 26/00

(52) U.S. Cl. 359/238

(57) ABSTRACT

A polarizer device, for converting an entry light beam into an exit light beam with a defined spatial distribution of polarization states, has an angle varying input device for receiving the entry light beam and for generating a first light beam with a predeterminable first angular distribution of light rays; an angle-selectively active polarization influencing device for receiving the first light beam and for converting the first light beam into a second light beam according to a defined angle function of the polarization state variation; and an angle varying output device for receiving the second light beam and for generating the exit light beam with a second angular distribution from the second light beam. In particular, polarization states with a radial or tangential polarization can be provided cost-effectively in this way.

This application claims benefit from U.S. Provisional Application No. 60/585,842 filed on Jul. 8, 2004. The complete disclosure of that provisional application is incorporated into this application by reference.

### BACKGROUND OF THE INVENTION

1. Field of the Invention

The invention relates to a polarizer device for converting an entry light beam into an exit light beam with a predeterminable spatial distribution of polarization states, and to an optical system which contains at least one such polarizer device. A preferred field of application is the microlithographic production of finely structured semiconductor components and other components with the aid of projection lithography.

2. Description of the related Prior Art

Projection exposure apparatus for microlithography have been used for decades for the photolithographic production of semiconductor components and other finely structured components. They are used to project the pattern of a mask (reticle) onto an object coated with a photosensitive layer, with maximum resolution on a reducing scale. In order to be able to generate finer and finer structures, attempts are made to constantly increase the numerical aperture (NA) on the image side of the projection objective, values of NA=0.7 or more being achievable at present. Furthermore, shorter and shorter wavelengths in the deep ultraviolet (DUV) range or in the vacuum ultraviolet (VUV) range are being used.

Under conditions of short wavelengths and high numerical apertures, the influence of polarization effects on the imaging quality becomes increasingly perceptible. For example, with high numerical apertures, for example at values of NA=0.85 or more, the vector character of the image-generating electric field increasingly becomes significantly noticeable. It has been found that the s-polarized component of the electric field, i.e. the component which oscillates perpendicularly to the incidence plane spanned by the incidence direction and the surface normal of the substrate, interferes better and generates better contrast than the p-polarized component oscillating perpendicularly to it. On the other hand, p-polarized light generally enters the photoresist better. It has therefore already been proposed, depending on the application, to operate at high apertures with specifically polarized light, for example with tangential polarization or radial polarization. Circularly polarized or unpolarized light is often also desirable.

DE 195 35 392 (which corresponds to U.S. Pat. No. 6,191,880 B1) discloses a polarizer device operating in transmission, which is intended for use in the illumination system of a projection exposure apparatus and, according to the dimensioning, converts an entry light beam into an exit light beam which can be polarized radially or tangentially over its full cross section. An embodiment operating in transmission, to convert linearly polarized entry light into radially polarized exit light, has a multiplicity of hexagonal half-wave plates of birefringent material which are arranged so as to fill the surface, and the principal crystallographic axes of which are aligned perpendicularly to the incidence direction of the entry light so that each half-wave plate deviates the polarization direction of the locally incident light in the direction of a radius, directed onto the optical axis of the polarizer device, which intersects the half-wave plate. The polarizer device designed as a space variant retarder, i.e. as a retardation device with a retardation effect varying over its cross section, operates in principle without losses but is relatively expensive to produce.

The patent application also presents radial polarizers which have a hollow-bored cone frustum of transparent material with an apex angle corresponding to the Brewster angle and a dielectric reflection coating on the cone surface. The s-polarized component of the entry light is reflected at the coated cone surface, so that the transmitted component is polarized parallel to the incidence plane and therefore radially with respect to the optical axis. A similar device is known from U.S. Pat. No. 5,365,371.

U.S. Pat. No. 4,755,072 discloses polarizing axicon arrangements which, with the aid of conical surfaces, can generate exit light beams which have either a radial or a tangential privileged polarization direction, relative to the optical axis, at each point of their cross section. The production of conical surfaces on optical elements is technologically elaborate.

DE 101 24 803 (which corresponds to U.S. 2002/0176166 A1) in the name of the Applicant discloses another polarizer device operating in transmission with a spatially varying effect.

The German patent application DE 103 24 468.9 in the name of the Applicant corresponding to U.S. 2004/0257553 A1, describes microlithographic projection exposure apparatus in which transparent retardation elements are used in order to set a desired spatial polarization distribution, which have form birefringent grating structures whose arrangement varies locally over the working cross section in order to generate a space variant retarder.

The U.S. patent application with the Ser. No. 10/721378 discloses retardation devices operating in reflection with an effect varying over their cross section.

### SUMMARY OF THE INVENTION

It is an object of the invention to provide a polarizer device for generating a light beam with a defined spatial polarization distribution, the production of which is relatively simple and cost-effective. It is another object to provide means to provide cylindrically symmetric distributions of locally differing privileged polarization directions, in particular radial polarization or tangential polarization, with a tolerable manufacturing outlay.

To address these and other objects the invention, according to one formulation of the invention, provides a polarizer device for converting an entry light beam into an exit light beam with a defined spatial distribution of polarization states, having:

an angle varying input device for receiving the entry light beam and for generating a first light beam with a predeterminable first angular distribution of light rays;

an angle-selectively active polarization influencing device for receiving the first light beam and for converting the first light beam into a second light beam according to a defined angle function of the polarization state variation; and

an angle varying output device for receiving the second light beam and for generating the exit light beam with a second angular distribution from the second light beam.

From an entry light beam which is unpolarized, or has a given spatial distribution of polarization states, such a polarizer device generates an exit light beam with a polarization state position distribution modified with respect thereto. This spatial distribution will also be referred to below as a “polarization distribution” for brevity.

The polarization states within the polarization distribution generally differ locally, so that the exit light beam is not uniformly polarized over its cross section. The input device has a ray angle varying effect in order to generate, from the entry light beam which has a particular angular distribution, a first angular distribution of the light rays which can be adjusted accurately by the structure of the input device. The angle-selectively active polarization influencing device, which will also be referred to below as an “angle variant polarization influencing device”, is exposed to this first angular distribution and causes a polarization change of the first light beam according to an active polarization state change function predetermined by the structure of the polarization influencing device. The first angular distribution is adjusted with the aid of the input device so that, in conjunction with the angle selective action of the polarization influencing device, a specific polarization state change is achieved for each ray angle in the second light beam which leaves the polarization influencing device. The angle-varyingly active output device receives the second light beam and generates therefrom the exit light beam, the ray angle distribution of which differs from the ray angle distribution of the second light beam and is adapted to the requirements of the subsequent optical elements in the optical path.

In polarizer devices according to the invention, therefore, a light-ray specific polarization influence varying over the beam of rays essentially takes place in angle space, while the effect on the polarization state in position variant polarizer devices of the prior art essentially takes place in position space (location space). Angle-variantly active polarization influencing devices, which can be produced relatively straightforwardly compared to position variant polarization influencing devices, can therefore be used to generate defined spatial polarization distributions.

In one embodiment, the angle-selectively active polarization influencing device comprises at least one polarizing layer, which is arranged on a layer carrying substrate. This makes it possible to provide polarizer devices which are relatively straightforward to produce and which can optionally be integrated in optical systems with only minor technical outlay. The polarizing layer is in this case designed such that it has a polarization-selective action dependent on the angle of incidence, so that the effect of the polarizing layer on the polarization of the light depends on the one hand on the angle of incidence of a light ray and, on the other hand, on its polarization state. The term “angle of incidence” here refers to the angle formed between the incidence direction of a light ray and the surface normal of the polarizing layer at the point of incidence. Normal light incidence therefore corresponds to an angle of incidence of 0° and the angle of incidence increases with more oblique illumination of the polarizing layer.

In preferred embodiments, the polarizing layer is designed as a polarization beam splitter layer. Such layers, which are also referred to as “sp beam splitter layers”, may for example be formed by a multiple layer system of stacked layers with dielectric materials of different refractive indices. At the interfaces of the layer system, the reflection coefficients for p-polarizied and s-polarized light generally differ. As a rule, s-polarized light is reflected more strongly so that p-polarized light is transmitted better. This selective transmission and reflection influences the intensities of s- and p-polarizations differently, and leads to a polarization state change dependent on the angle of incidence. This effect is used for constructing the polarizer device.

The aforementioned polarization-selective transmission and reflection in principle take place in all alternating dielectric layer systems, and also in conventional antireflection coatings (AR layers). These, however, are typically designed for minimal sp splitting in order to minimize polarization effects. Conversely, polarization beam splitter layers in the context of this application are optimized so that there is maximal sp splitting, i.e. maximally different transmission and reflection levels for different polarization states, at least in the relevant angle of incidence range. In particular, it is preferable to use polarization beam splitter layers which are capable of generating at least 50% polarized light, i.e. light with a polarization level of 0.5 or more, from unpolarized light at least in a part of the relevant angle of incidence range.

If the splitting efficiency achievable by a single polarizing layer is insufficient to generate an intended polarization level, then it is also possible to arrange at least two polarization layers successively in the light propagation direction, so as to provide a cascade of polarized layers whose overall splitting efficiency is greater than that of a single layer. For example, the entry side and the exit side of a transparent plate may each be covered with a polarization splitter layer. It is also possible to provide a plurality of coated substrates disposed in succession. The individual layers of a cascade may essentially be constructed identically, so as to facilitate production. When cascading, it should be borne in mind that perturbing effects such as scattered light are amplified by disposing a plurality of layers in succession. A small number of successively disposed polarizing layers is therefore often favorable, for example two polarizing layers.

The polarization splitter layer may be designed so that it has a higher transmissivity for p-polarized light than for s-polarized light, at least in a predominant part of the angle of incidence range encountered during exposure to light with the first angular distribution. This situation exists in many conventional multiple dielectric layer systems, the difference or splitting and therefore the polarization-selective effect being particularly large in the Brewster angle range. Such polarization splitter layers can be produced with large sp splitting and used particularly straightforwardly to generate radial polarization.

In other embodiments, the polarization splitter layer is designed so that it has a higher transmissivity for s-polarized light than for p-polarized light, at least in a predominant part of the angle of incidence range encountered. In particular, a tangential polarization of the exit light beam can thereby be adjusted directly. Such polarization splitter layers typically have a lower splitting efficiency than those which preferentially transmit p-polarized light. It may therefore be favorable to dispose at least two polarizing layers in succession (cascading).

The polarization splitter layer may have a generally aperiodic layer structure, in which the optical layer thicknesses of some or all stacked high-index and low-index dielectric layers lie between about 20% and about 60% of the working wavelength λ₀ intended for the polarization splitter layer. Conventional sp beam splitter layers can be used in this case, for example a suitable MacNeille design. As is known, two materials which have the same effective refractive index for the p-component at a particular angle are referred to as a MacNeille pair.

It is also possible to construct the angle-selectively active polarization influencing device by using so-called “form birefringence”. For example, a polarization splitter layer may be constructed using a periodic structure of stacked layers of differently refracting dielectric materials, in which the periodicity length of the periodic structure is small compared with the working wavelength, so as to produce a uniaxial birefringence structure whose optical axis intended for the birefringence is perpendicular to the surface of the periodic structure. Polarization beam splitters having polarization splitter layers constructed in this way are known, for example, from U.S. Pat. No. 6,384,974 for the visible wavelength range.

It is also possible for the polarization influencing device to contain a layer in combination with a lateral structure on at least one of its surfaces, which has a higher transmissivity for one polarization component than for the other polarization component, in order to achieve polarization-selective sp splitting. The laterally structured layer preferably has form birefringent grating structures, whose spacing from one another is less than the working wavelength. Form birefringence takes place here as a result of the inhomogeneous material distribution in the grating and occurs above all when the spacing of the grating structures is smaller than the wavelength of the incident light. The lateral spacing of the grating structures is preferably less than 70%, in particular less than 30%, of the working wavelength. Such diffractive optical elements may, for example, be produced in a photolithographic process. The form birefringent lateral structure may be designed so as to influence the angle dependency and/or the wavelength dependency of the polarization influence. In this way, for example, polarizing beam splitters with a large angle acceptance can be produced. Form birefringent multilayer polarization beam splitters are known, for example, from the article “Design, fabrication and characterization of formbirefringent multilayer polarizing beam splitter”, by R.-C. Tyan, A. A. Salvekar, H.-P. Chou, C.-C. Cheng, A. Sherer, P.-C. Sun, F. Xu and Y. Fainman in: J. Opt. Soc. Am. A/vol. 14, No 7/July 1997, pages 1627 ff.

Angle-selectively active polarization influencing devices with one or more polarizing layers generally require little installation space and can sometimes be produced by modifying existing optical components in an optical system. In one embodiment, the substrate surface of the layer carrying substrate, on which the polarized layer is provided, is essentially flat. The substrate may have the form of a plane-parallel plate. In the case of an essentially flat polarizing layer, the angle of incidence distribution is essentially constant over the entire illuminated cross section.

The layer carrying substrate may also be a lens with at least one convexly or concavely curved substrate surface, on which the polarizing layer is applied. In such a case, the angle of incidence distribution locally arriving on a layer position is a function of the position, or the distance from the optical axis, since the locally occurring angle of incidence distribution depends both on the first angular distribution and on the alignment of the relevant surface region relative to the optical axis of the system.

As an alternative or in addition to a polarization-selectively active polarizing layer, the polarization influencing device may also contain other angle-selectively active polarization influencing elements, for example a plate of a birefringent crystal material.

The input device converts the entry light beam, preferably substantially without losses, so as to achieve the intended first angular distribution of the first light beam, which leads to an intended angle of incidence distribution at the angle variant polarization influencing device. The input device is in this case preferably designed so that the first angular distribution has a first numerical aperture NA_{1>0.2}, in which case NA_{1>0.5} may in particular be provided. At the polarization influencing device, it is therefore possible to generate a broad angle of incidence spectrum which also includes angles of incidence at which the polarization varying effect is maximal. If a polarization splitter layer is provided as the polarization influencing device, for example, then the angle of incidence distribution should include the corresponding Brewster angle at which the sp splitting is maximal.

In one embodiment, the input device has a positive overall refractive power and defines a rear focal plane, in the region of which an entry light beam incident axially parallel is focused. The output device likewise has a positive overall refractive power and defines a front focal plane, which essentially coincides with the rear focal plane of the input device so as to provide a so-called 2f structure overall. The polarizer device may, in particular, be adapted to an entry light beam which has a numerical aperture NA_{E}<0.1 on the entry side, and preferably provides an exit light beam with a comparably low numerical aperture. Such a polarizer device may be installed in a region of substantially collimated radiation inside an optical system, and it converts a substantially collimated entry light beam into a substantially collimated exit light beam, there being a high numerical aperture region between the input device and the output device, where the polarization influencing device can be arranged.

In order to limit the radiation exposure at the position of the polarization influencing device, the polarization influencing device should not lie in the region of the coincident focal planes, which is also referred to here as the “focal region”, but outside the focal region, before or after it (i.e. upstream or downstream) in the optical path. The polarization influencing device may, in particular, be arranged in the optical path upstream of the focal region so that an aperture can be placed in the region of the focus. In this way, it is possible to block scattered light which may be caused inter alia by imperfections of the polarization influencing device.

The input device may be designed, for example by exclusively using lenses with spherical lens surfaces, so that the first light beam striking the polarization influencing device has an essentially spherical wavefront. In particular, a cylindrically symmetrical polarization distribution of the exit light beam can thereby be generated, in which the polarization state may be radial or tangential. By generating an aspherically shaped wavefront of the first light beam, it is also possible to generate general polarization states of the exit light beam. To this end, for example, cylindrical lenses and/or rotationally symmetric aspheres may be provided in the input device and the output device.

In order to achieve the opportunity for further optimization of the polarization distribution of the exit light beam, a manipulation device may be provided for moving the polarization influencing device relative to the input device and the output device. It may be designed so that the polarization influencing device can be tilted in relation to the optical axis and/or displaced relative to the optical axis, in which case both axial displacement and radial displacement may be provided. Rotation about a rotation axis extending parallel to the optical axis may also be provided. In particular through combination with aspherical lenses, it is possible to increase the achievable parameter space for polarization states within the emerging polarization distribution.

In order to be able to use the optical device equipped with the polarizer device selectively with polarization influence or without polarization influence, in preferred embodiments the polarization influencing device is to be made interchangeable so that it can selectively be inserted into the beam path or removed therefrom. To this end, a changer device may be provided which may optionally be integrated in a manipulation device as part of it.

In many embodiments, the polarization influencing device is intended to be usable in transmission, so that the polarization distribution of the exit light beam is determined by the properties of the transmitted radiation. It is also possible to use a polarization influencing element acting angle-dependently in reflection, so that the emerging polarization distribution is determined by the properties of the reflected radiation. Examples of this are presented in the international patent application with the file reference PCT/EP03/11977 and application date Oct. 29, 2003 in the name of the Applicant and published as WO 2005/031467 A. The content of this patent application is incorporated into the content of this description by reference.

The polarizer device may be designed so that the emerging polarization distribution is determined exclusively by the properties of the angle-selectively active polarization influencing device, for example in order to adjust a radial or tangential polarization. It is nevertheless possible to provide the polarizer device with at least one further polarization influencing device, in order to modify the polarization distribution. For example, a polarization rotator may be provided in order to rotate the privileged polarization directions existing behind (downstream of) the polarization influencing device. For example, a rotator which leads to a rotation through 90° can convert a polarization distribution with radial polarization into a polarization distribution with tangential polarization (or vice versa). For example, a plate of an optically active material may be used as the polarization rotator, which is inserted behind the polarization influencing device in the beam path. The rotator may be interchangeable, for example in order to permit a straightforward changeover between radial and tangential polarizations.

The invention can be used advantageously in various fields of application. For example, the polarizer device may be provided in the illumination system of a projection exposure apparatus. In a preferred embodiment, an angle-selectively active polarization influencing device, in particular a plane plate with a polarization-selectively active layer, may be placed for this purpose in the region of a field plane of the illumination system having high-aperture exposure. In this case, preceding elements in the optical path, which may in particular comprise at least one light integrator to homogenize the illumination radiation, are used as the input device in order to generate the intended first angular distribution at the position of the polarization influencing device, while subsequent optical elements in the optical path may be used as the output device. In this way, a polarizer device can be produced straightforwardly by using optical elements of the illumination system which are already present.

It is also possible to use the invention inside a microscope. For example, the input device and the output device may be designed so that they can be installed inside a tube lens of a microscope, or so that they can be used as a tube lens. The polarization influencing device may then be provided in the region of an intermediate image inside the tube lens. The polarization influencing device should be interchangeable, in order to be able to produce various polarization states.

These and other features are disclosed by the claims as well as by the description and the drawings, and the individual features may respectively be implemented separately or together to form sub-combinations in embodiments of the invention and for other fields, and may constitute both advantageous and per se protective versions.

### BRIEF DESCRIPTION OF THE DRAWINGS

FIG. 1 is a schematic representation of an embodiment of a polarizer device according to the invention;

FIG. 2 is a schematic diagram of the angle of incidence dependency of the reflectivities Rₚ and Rₛ in a polarization splitter layer with Rₛ>Rₚ (a) and a schematic representation of a spatial polarization distribution with radial polarization in an exit light beam (b);

FIG. 3 is a schematic diagram of the angle of incidence dependency of the reflectivities Rₚ and Rₛ in a polarization splitter layer with Rₛ<Rₚ (a) and a schematic representation of a spatial polarization distribution with tangential polarization in an exit light beam (b);

FIG. 4 is a schematic representation of another embodiment of a polarizer device with spherical lenses for the input and output of light;

FIG. 5 is a schematic representation of another embodiment of a polarizer device with aspherical lenses for the input and output of light;

FIG. 6 schematically shows an embodiment of a polarizer device in which a beam splitter layer is applied on a convex entry side of a positive lens;

FIG. 7 schematically shows an exemplary embodiment of a projection exposure apparatus for microlithography, in which an interchangeable polarization splitter plate is provided in the illumination system;

FIG. 8 shows a detail of another embodiment of an illumination system, in which the polarizer device comprises a polarization beam splitter coating on the exit surface of a rod integrator;

FIG. 9 schematically shows a detail of another illumination system of a microlithography projection exposure apparatus, the illumination system comprising a fly's eye condenser for light mixing;

FIG. 10 schematically shows an embodiment of a microscope in which an embodiment of a polarizer device is integrated.

### DETAILED DESCRIPTION OF THE PREFERRED EMBODIMENTS

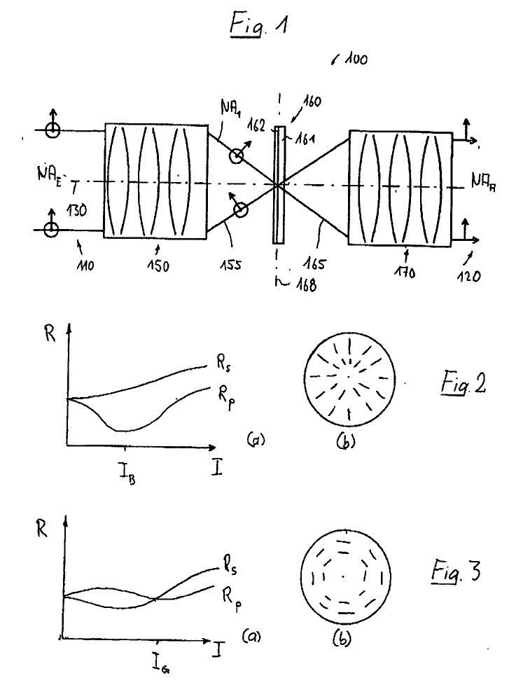

FIG. 1 schematically shows an embodiment of a polarizer device 100 which is designed to convert an entry light beam 110, which enters the polarizer device from the left in the representation, into an emerging (toward the right in the figure of the drawing) light beam 120 which has a defined position distribution of polarization states over the cross section of the exit light beam. The polarizer device, designed for the deep ultraviolet (DUV) range, is configured so that a substantially collimated entry light beam 110 with a numerical aperture NA_{E}<0.1 on the entry side is converted into a likewise substantially collimated exit light beam with a numerical aperture NA_{A}<0.1 on the exit side. The unpolarized entry light beam in this case becomes an exit light beam with radial polarization, i.e. with an alignment of the privileged polarization direction varying spatially over the cross section of the exit light beam, the privileged polarization direction being aligned in a radial direction with respect to the optical axis 130 of the system at any point of the cross section of the beam of rays (FIG. 2(b)).

The polarizer device comprises an angle varying input device 150, which may comprise one or more lenses with a positive refractive power and, with the aid of an overall positive refractive power, generates a convergent exit light beam 155 with a defined first angular distribution, which is characterized by a numerical aperture NA₁>NA_{E}, from the substantially parallelized entry light beam. In the exemplary case, a relatively high-aperture first light beam is generated with NA_{1>0.2}, preferably NA_{1>0.5.}

An angle-selectively active polarization influencing device 160, which comprises a plane-parallel transparent plate 161 aligned perpendicularly to the optical axis 130 and a polarization splitter layer 162 applied on the entry side of the plate 161, which is also referred to below as the “a beam splitter plate”, is arranged in the region of the rear focal plane 168 of the input device 150. The polarization influencing device 160, which is used in transmission, has a virtually negligible effect on the angular distribution of light rays so that a second light beam 165, whose second angular distribution corresponds essentially to the first angular distribution of the first light beam 155, emerges from its light exit side.

An angle varying output device 170 which, with the aid of an overall positive refractive power provided by one or more lenses, transforms the divergent second light beam 165 into a substantially parallelized exit light beam 170, is arranged at a distance behind the beam splitter plate 160. The front focal plane 168 of the output device in this case coincides with the rear focal plane of the input device, so as to form overall a so-called 2f arrangement in the focal region 168 of which the beam splitter plate 160 is located.

The polarization splitter layer 162 applied on the plate-shaped substrate 161 consists of a multiple alternating dielectric layer system, in which individual layers of high-index dielectric material and low-index dielectric material are applied alternately on one another. At the interfaces of the layer system, the reflectivities Rₚ for p-polarized light and Rₛ for s-polarized light differ at non-normal light incidence, so that overall one of the polarization components is transmitted more strongly and the other is reflected more strongly.

A profile of the reflectivities Rₛ and Rₚ as a function of the angle of incidence I, which is typical of conventional multiple layers, is schematically shown FIG. 2(a). These reflectivities are equal for normal incidence (angle of incidence 0°). As the angle of incidence increases, the reflectivity for s-polarization increases monotonically, while the reflectivity for p-polarization initially decreases as far as the Brewster angle I_{B} and then rises again as the angle of incidence increases further. Rₛ>Rₚ therefore applies throughout the angle of incidence range for conventional beam splitter layers, particularly strong reflectivity differences or particularly pronounced sp splitting being obtained in the range of the Brewster angle I_{B}.

In order to obtain sufficiently strong polarization selection, polarization splitter layers of preferred embodiments are designed so that light with a polarization level of at least 0.5 can be generated from unpolarized light for light rays in the region of the Brewster angle. In an embodiment for λ₀=193 nm, a modified MacNeille design with 31 individual layers is provided as the polarization splitter layer, in which the reflectivity Rₚ at the minimum (for the Brewster angle) is Rₚ=0.0004, while Rₛ=0.983 for the same angle. The multiple dielectric layer system has the following structure: S/H/(L/H)¹⁵. Layers of high-index (H) lanthanum fluoride (LaF₃) with a refractive index n=1.67 and low-index (L) magnesium fluoride (MgF₂) with a refractive index n=1.44 are applied alternately on a synthetic quartz glass substrate S. The layer closest to the substrate consists of LaF₃, on which 15 MgF₂/LaF₃ layer pairs are applied. The geometrical layer thicknesses are respectively d=38.5 nm for the LaF₃ layers and d=51.7 nm for the MgF₂ layers. The structure can therefore also be characterized as follows by optical layer thicknesses n*d: S/H 0.33 λ₀/(L 0.39 λ₀/H 0.33 λ₀)¹⁵.

For the flat polarization splitter layer 162 placed perpendicularly to the optical axis 130, the angle of incidence exposure is equal over the entire cross section and corresponds to the first angular distribution of the first light beam 155. In this case, rays propagating axially parallel experience no sp splitting. The absolute amount of the sp splitting then increases with growing angles of incidence as far as the Brewster angle. The first angular distribution is adapted to the beam splitter layer so that the rays arriving with the highest aperture angles have angles of incidence in the region of the Brewster angle, and are therefore split strongly and predominantly exhibit p-polarization after passing through the plate. The effect of the Fourier transform due to the output device is then that of the regions of the beam of rays lying at the outer edge of a subsequent pupil plane (FIG. 2(b)) predominantly exhibit radial polarization, the polarization level decreasing from the edge of the pupil to the central region near the axis.

The same principle can also be used to generate a predominantly tangentially polarized exit polarization state behind the output device 170. To this end, instead of the polarization splitter layer 162, in one embodiment a multilayer polarization splitter layer is used which transmits s-polarization more strongly than p-polarization in the relevant angle of incidence range. FIG. 3(a) in this regard schematically shows the angle of incidence dependency of suitable polarization splitter layers. Here again, the reflectivities Rₛ and Rₚ for normal light incidence are the same, although sp splitting takes place after this as the angles of incidence increase, so that the reflectivity for s-polarization is less than that for p-polarization up to a limit angle of incidence I_{G}. Behind the polarization influencing device 160, above all at those angles which correspond to the maximum splitting, the second light beam 165 contains predominantly s-polarized light which is transformed by the output device into a tangential polarization of the exit light beam (FIG. 3(b)).

In both cases, a spatial polarization distribution in which the polarization level, i.e. the extent to which a privileged polarization direction is expressed, increases is created in the exit light beam from the middle of the pupil toward the edge of the pupil. This can be favorable since the reasons described in the introduction, which account for the selection of radial or tangential polarization, are encountered particularly for rays guided into a field plane with a high numeral aperture, so that the polarization distribution is advantageously adapted to the requirements of the imaging task.

The polarizer device may contain a gray filter which has a spatial transmissivity variation over its illuminated cross section in order to influence the intensity distribution within the beam of rays. The gray filter may, for example, be used to compensate for nonuniform transmission in order to ensure an essentially constant intensity distribution over the beam cross section.

FIG. 4 shows another embodiment of a polarizer device 400. Features or groups of features which are the same or correspond to one another are characterized by the same references as in FIG. 1, increased by 300.

In this embodiment, the input device 450 and the output device 470 respectively consist of a single positive meniscus lens with substantially corrected spherical aberration, so that a collimated entry light beam 410 is converted in to a spherical wave converging at the focus 468, and the spherical wave diverging again behind the focal region is transformed back into an axially parallel exit light beam 420 by the output device. In order to reduce the radiation exposure of the polarization splitter layer, the polarization splitter layer 462 should not lie directly in the focal region, but axially before or after it. The transmitted wave is invariant with respect to displacement of the beam splitter layer parallel to the axis. The reflected radiation is, however, modified by such a displacement. For example, the focus of the reflected wave can be used in order for the reflected wave to be deliberately blocked, for example using an aperture, or output. In the embodiment, the polarization splitter plate 460 is arranged at a distance in front of the focal region 468. In the focal region itself, a scattered light aperture 469 is provided which can block scattered light that may be caused inter alia by imperfections of the beam splitter layer.

In unconventional beam splitter layers, which are designed for stronger transmission of s-polarized light (cf. FIG. 3) the reflectivity difference or transmission difference between s- and p-polarizations, considered in absolute terms, is not as great as the reciprocal difference in conventional beam splitter layers (cf. FIG. 2). A radial polarization is therefore simpler to achieve without further measures than the tangential polarization. With the embodiment according to FIG. 4, it is possible to generate radial and tangential polarizations with comparable quality. By using a conventional beam splitter layer 462, radial polarization is created in the exit light beam. If tangential polarization is desired, then a transparent polarization rotator 490, which is designed to generate a rotation of the privileged polarization direction through 90° over its entire cross section, is put into the exit light beam 420 behind the output device in the beam path, so that radial polarization before the polarization rotator is converted substantially without losses into tangential polarization behind the polarization rotator.

In the exemplary embodiment, an interchangeable plate of an optically active material is used as the polarization rotator. As is known, optically active materials have the property of rotating the polarization of transmitted light, the angle of rotation being proportional to the material thickness and the constant of proportionality increasing as the wavelength decreases. In the exemplary case, a thin quartz crystal plate 490 is used as the polarization rotator. The crystallographic axis of the optically active material, indicated by an arrow, is in this case aligned essentially parallel to the optical axis 430 of the polarizer device or perpendicular to the plane of the plate, i.e. parallel to the plate normal. The use of quartz crystal plates for polarization rotation through 90° inside a projection objective for microlithography is described, for example, in U.S. patent application U.S. 2002/0186462 A1 in the name of the Applicant, the disclosure content of which is incorporated into this description by reference.

An alternative to the quartz crystal plate polarization rotator 490 consists in constructing a 90° polarization rotator by arranging two λ/2 retardation plates of birefringent material successively so that the principal crystallographic axes of the birefringent material, which lie in the respective plate planes, are mutually rotated through 450.

In the embodiment, the polarization influencing device 460 is made interchangeable so that, as an alternative, it is possible to select another polarization or no polarization influence at all. To this end, for example, the beam splitter plate 460 may be mounted inside a revolver wheel or framed inside another changer device.

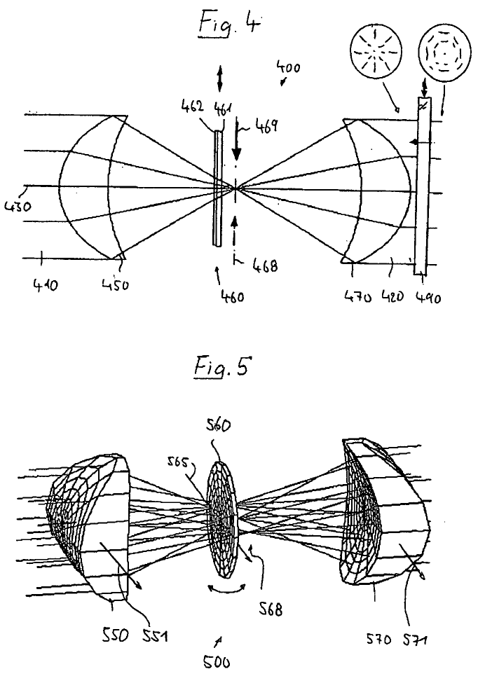

In the configurations described above, the converging wave incident on the beam splitter layer has a spherical phase front, and the transmitted polarization state is radial or tangential. By generating an aspherically shaped wavefront of the first light beam directed at the polarization influencing device, it is also possible to generate general polarization states. In this regard, FIG. 5 shows by way of example an embodiment of a polarizer device 500 in which the input device 550 and the output device 570 are constructed with the aid of cylindrical lenses, which generate a linear polarization increasing transversely with respect to the cylinder axis 551, 571. By using rotationally symmetric aspheres in the input device and the output device, it is possible to vary the relation between the beam height before the input optics and the angle of the corresponding ray with respect to the optical axis behind the input optics, and therefore the radial profile of the polarization. In this case, the intermediate focus 568 may contain significant spherical aberrations which are intended to be compensated for with the aid of the output device 570.

In order to be able to adapt the polarization state of the exit light beam optimally to a particular application, the polarization beam splitter plate 560 in the embodiment of FIG. 5 can be tilted about a tilting axis 565 which is aligned perpendicularly to the optical axis 530, parallel to the cylinder axes of the cylindrical lenses 550, 570. A correspondingly designed manipulator device is provided for this purpose. With the aid of tilting, it is possible for the position where a light ray strikes the beam splitter layer perpendicularly, and therefore experiences no polarization splitting, to be displaced inside the pupil. In particular, this point may thus lie away from the optical axis. By combination with aspherical lenses, it is possible to increase the achievable parameter space for polarization states.

In the embodiments, the principle explained here with reference to a few examples is that an intended distribution of the linear polarization in the pupil is converted into an angular distribution, and this is then transformed into a polarization distribution by a polarization varying layer, in particular an sp beam splitter layer. The symmetry of the angular distribution then determines the symmetry of the polarization distribution.

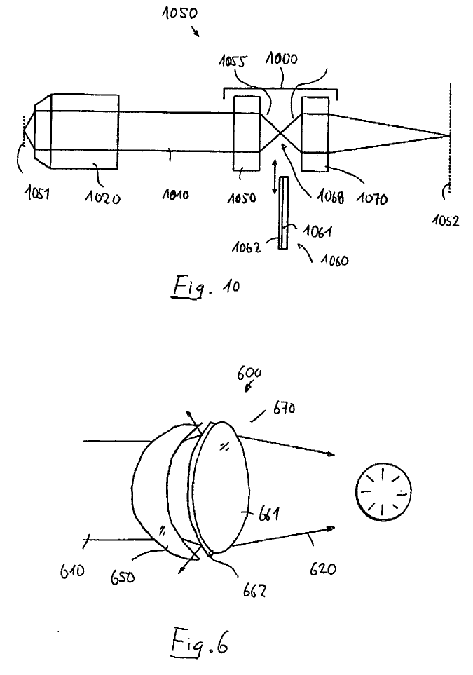

Another embodiment of a polarizer device 600 will be explained with reference to FIG. 6, in which the polarization effective component of a polarization influencing device is formed by a multilayer dielectric beam splitter layer 662. The angle varying input device is formed by a positive meniscus lens 650 with a concave surface on the exit side. This is followed directly by a biconvex positive lens 670 used as the output device. The beam splitter layer 662 is applied on the very convexly curved entry side of the positive lens 670, the lens body of which is used as a layer carrying substrate for the beam splitter layer 662. The polarizer device 600 is designed to convert an axially parallel, substantially collimated incident entry light beam 610 (NA_{E}=0.01) into a slightly convergent exit light beam 620 with a radial polarization. The first light beam arriving on the beam splitter layer is slightly divergent and provides a relatively narrow angular spectrum of between 0° and about 20°. In combination with the curvature of the beam splitter layer 662, a substantially broader angle of incidence spectrum of between 0° and more than 40° or 50°, which includes the Brewster angle of the beam splitter layer 662, is generated on the latter. Owing to the convex curvature of the beam splitter layer, the angles of incidence increase outward from the region of the optical axis 630 more strongly than the ray angles of the light beam, the angles of incidence varying over the position. A variation of the privileged polarization direction from the middle of the pupil to its edge is therefore obtained in the pupil.

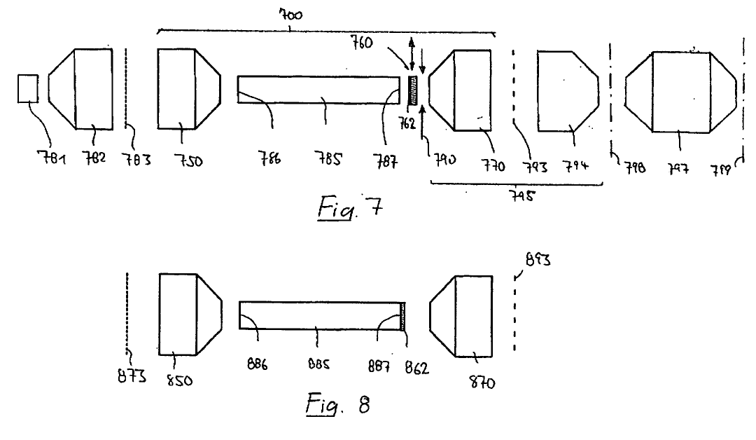

Various exemplary applications of the invention inside illumination systems for microlithography projection exposure apparatus will be explained with reference to FIGS. 7 to 10.

FIG. 7 schematically shows a projection exposure apparatus, which can be used for the microlithographic production of finely structured semiconductor components and, in order to achieve resolutions as small as fractions of micrometers, operates with light in the deep ultraviolet (DUV) range which is provided by a primary light source 781 (for example a laser). The linearly polarized light from the light source first enters a pupil shaping unit 782, which is designed to generate a two-dimensional light distribution, predeterminable by the configuration of the pupil shaping unit, in a first pupil plane 783. The pupil shaping unit contains depolarizing optical elements, so that the light is substantially unpolarized in the pupil plane 783. An input device 750 arranged behind it transfers the light onto the flat entry surface 786 of a rod integrator 785 consisting of transparent material, which is used as the light mixing device of the illumination system. The position distribution of the illumination in the pupil plane 783 is then converted into a corresponding angular distribution at the entry surface 786, which is arranged in a field plane of the illumination system. The integrator rod 785 homogenizes the illumination light by multiple internal reflection on the flat side surfaces of the rod, the angular distribution generated by the input device 750 being preserved and therefore also being present on the flat exit surface 787 of the rod 785. Directly at the exit surface 787, there is a further field plane in the vicinity of which a reticle masking (REMA) system 790 is arranged, which is used as an adjustable field aperture. A subsequent imaging system 795 (REMA objective) images the field plane with the masking system at 790 onto the exit plane 798 of the illumination system, in which a reticle with a structure to be imaged is arranged during operation of the projection exposure apparatus. The imaging objective 795 contains a first lens group 770, which is used as an output device in order to convert the angular distribution of the exit plane 787 into a position distribution of the illumination in a further pupil plane 793, and a further lens group 794 which performs a Fourier transform of this position distribution to form the ray angle distribution of the reticle plane 798. A projection objective 727 images the structure of the reticle on a reduced scale into its image plane 799, in which the wafer to be exposed can be arranged.

In this application, the polarizer arrangement 700 is arranged between two consecutive pupil planes 783, 793 of the illumination system and comprises the input device 750, the rod integrator 785, the output device 770 and the polarization influencing device 760, arranged in the vicinity of an intermediate field plane in the high numerical aperture region, which consists of an interchangeable plane plate with a polarization splitter layer 762 applied on it. A coating used as a gray filter with a spatially varying transmission profile may be applied on the plate, for example on the other plate surface. The gray filter may be used to adjust a constant intensity distribution over the beam cross section. When it passes through the rod integrator 785, the light substantially unpolarized in the entry pupil 783 of the illumination system is depolarized further, since the oblique reflections on the rod outer surfaces lead to angle dependent phase shifts between the polarization components. The light emerging with a first angular distribution at the rod exit 787 is therefore substantially unpolarized. The polarization splitter layer 762 is designed so that p-polarized light is transmitted substantially better, above all at high ray angles of between 30° and 50°, than p-polarized light. This leads to a predominantly radially polarized polarization state in the exit pupil 793 of the illumination system. The reticle is then illuminated with this radially polarized light in the reticle plane 798.

Further details about the structure and functionality of such an illumination system (without a polarizer device) can be found, for example, in EP 0 747 772 A1 in the name of the Applicant, the content of which is incorporated into the content of this application by reference. Especially with devices for modifying the illumination setting, for example with a zoom system and/or with optionally interchangeable diffractive or refractive optical elements inside the pupil shaping unit 782, it is possible to produce different degrees of radially or tangentially polarized illumination settings which can advantageously be used to increase resolution and improve contrast.

FIG. 8 shows a detail of a variant of an illumination system, in which elements which are identical or correspond to one another are provided with the same references as in FIG. 7, increased by 100. In contrast to the embodiment according to FIG. 7, the angle varying polarization influencing device is in this case formed by applying an angle-selectively active, polarization varying beam splitter layer 862 directly on the flat exit surface 887 of the rod integrator 895, so that the cuboid rod integrator 885 is used as a layer carrying substrate.

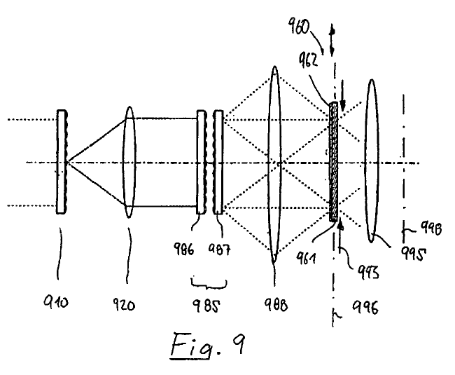

FIG. 9 shows a detail of another embodiment of an illumination system of a microlithography projection exposure apparatus, in which the light mixing and the homogenization are carried out with the aid of a honeycomb condenser 985. The light coming from a light source (not shown) is expanded, first strikes a refractive or diffractive optical grid element 910 for pupil generation, and subsequently passes through optics 920 which substantially parallelize the radiation. The substantially parallel light beam strikes the entry surface of a first grid arrangement 986 of lenses with identical positive refractive power and a rectangular cross section, which corresponds to the rectangular shape of the illumination field to be generated. The lenses of the first grid arrangement are arranged directly next to one another in a rectangular grid, in or close to a field plane of the illumination system, and are therefore also referred to as a field honeycomb. The lenses of the first grid arrangement cause geometrical splitting of the incident light beam into a number of light beams corresponding to the number of lenses, which are focused onto a pupil plane lying in the focal plane of the lenses. A second grid arrangement 987 with lenses of rectangular cross section and identical positive refractive power is positioned in or close to this plane. Each lens of the first grid arrangement images the primary light source onto a respectively assigned lens of the second grid arrangement, so that a multiplicity of secondary light sources are formed in the pupil plane. Owing to their positioning, the lenses lying close to the pupil plane are also referred to as pupil honeycombs. They are arranged close to the respective secondary light sources and, via a subsequent field lens 988, they image the assigned field honeycombs of the first grid arrangement onto a further field plane 996 of the illumination system. The rectangular images of the field honeycombs are then superimposed in this field plane so that this superposition causes homogenization or regularization of the light intensity in the region of this field plane. The field plane 995 corresponds to the exit planes 787, 887 of the integrator rods of the embodiments according to FIG. 7 and FIG. 8. An adjustable field aperture 993, which sharply delimits the illumination field, is arranged close to this field plane. The sharply delimited illumination field is imaged via the imaging objective 995 (REMA objective) into the exit plane 998 of the illumination system (reticle plane).

A plane-parallel plate 861 which is coated with a beam splitter layer 962, acts as an angle selective polarization varying device 960 and is exposed to the first angular distribution, which is provided by the field lens 988 and the preceding optical elements, is placed in the region of the field plane 996. These optical elements are accordingly used as an input device of the polarizer arrangement. The associated output device is then formed by the REMA objective or the subsidiary objective lying before its pupil plane. The functionality of the polarizer arrangement corresponds to that which was explained in detail above with reference to the other embodiments.

The use of the invention is not restricted to illumination systems of microlithography projection exposure apparatus. FIG. 10 schematically shows the structure of a microscope 1050, by which an object placed in the object plane 1051 of the DUV microscope is imaged into the image plane 1052 of the microscope with a magnifying imaging scale of 1:10 or more. The microscope essentially comprises a microscope objective 1020 with a high-aperture light entry side on the object side and a low-aperture light exit side, as well as a tube lens 1100 whose structure corresponds in principle to the exemplary embodiment of the polarizer device 100 as shown in FIG. 1. In this case, an input device 1050 generates a first light beam 1055 with a high aperture NA₁=0.7 from the low-aperture entry light beam 1010 with NA_{E}=0.02 coming from the objective 1020, so that an intermediate image is generated in the focal region 1080. This is imaged into the image plane 1052 with the aid of the output device 1070. The output device in this case has a finite refractive power on the image side. By inserting an interchangeable beam splitter plate 1060, the tube lens 1000 is selectively converted into a radial polarizer or a tangential polarizer, as a function of whether the beam splitter layer 1062 with high aperture exposure, which is applied on the transparent plane 1061, transmits p-polarization or s-polarization more strongly. Various polarization modes can be achieved owing to the interchangeability of the beam splitter plate.

1. A polarizer device for converting an entry light beam into an exit light beam with a defined spatial distribution of polarization states, comprising:
an angle varying input device for receiving the entry light beam and for generating a first light beam with a predeterminable first angular distribution of light rays;
an angle-selectively active polarization influencing device for receiving the first light beam and for converting the first light beam into a second light beam according to a defined angle function of the polarization state variation; and
an angle varying output device for receiving the second light beam and for generating the exit light beam with a second angular distribution from the second light beam.

2. The polarizer device as claimed in claim 1, wherein the angle-selectively active polarization influencing device comprises at least one polarizing layer, which is arranged on a layer carrying substrate.

3. The polarizer device as claimed in claim 2, wherein the polarizing layer is designed as a polarization beam splitter layer.

4. The polarizer device as claimed in claim 2, wherein the polarizing layer is formed by a multiple layer system of stacked layers with dielectric materials of different refractive indices.

5. The polarizer device as claimed in claim 3, wherein the polarization splitter layer is designed so that it has a higher transmissivity for p-polarized light than for s-polarized light, at least in a predominant part of an angle of incidence range encountered during exposure to light with the first angular distribution.

6. The polarizer device as claimed in claim 5, wherein the polarization splitter layer is used to generate radial polarization.

7. The polarizer device as claimed in claim 3, wherein the polarization splitter layer is designed so that it has a higher transmissivity for s-polarized light than for p-polarized light, at least in a predominant part of an angle of incidence range encountered during exposure to light with the first angular distribution.

8. The polarizer device as claimed in claim 7, wherein the polarization splitter layer is used to generate tangential polarization.

9. The polarizer device as claimed in claim 3, wherein the polarization splitter layer has a layer structure in which optical layer thicknesses of some or all stacked high-index and low-index dielectric layers lie between about 20% and about 60% of a working wavelength λ0 intended for the polarization splitter layer.

10. The polarizer device as claimed in claim 2, wherein the angle-selectively active polarization influencing device is constructed by using form birefringence.

11. The polarizer device as claimed in claim 3, wherein the polarization splitter layer is constructed using a periodic structure of stacked layers of differently refracting dielectric materials, in which a periodicity length of the periodic structure is small compared with a working wavelength λ0 intended for the polarization splitter layer.

12. The polarizer device as claimed in claim 2, wherein the polarization influencing device contains a polarizing layer in combination with a lateral structure on at least one of its surfaces.

13. The polarizer device as claimed in claim 12, wherein the lateral structure has form birefringent grating structures, which have a lateral spacing from one another which is less than a working wavelength λ0 intended for the lateral structure.

14. The polarizer device as claimed in claim 13, wherein the lateral spacing of the grating structures is less than 70% of the working wavelength.

15. The polarizer device as claimed in claim 2, wherein a substrate surface of the layer carrying substrate, on which the polarized layer is provided, is essentially flat.

16. The polarizer device as claimed in claim 2, wherein the substrate has the form of a plane-parallel plate.

17. The polarizer device as claimed in claim 2, wherein the layer carrying substrate is a lens with at least one convexly or concavely curved substrate surface, on which the polarizing layer is applied.

18. The polarizer device as claimed in claim 1, wherein the input device is designed so that the first angular distribution has a first numerical aperture NA1<0.2.

19. The polarizer device as claimed in claim 1, wherein the input device is designed so that the first angular distribution generates an angle of incidence spectrum at the polarization influencing device, which includes angles of incidence at which a polarization varying effect of the polarization influencing device is maximal.

20. The polarizer device as claimed in claim 1, wherein the polarizer device is adapted to an entry light beam which has a numerical aperture NAE<0.1 on the entry side.

21. The polarizer device as claimed in claim 1, wherein the polarizer device generates an exit light beam with a numerical aperture NAA<0.1 on the exit side.

22. The polarizer device as claimed in claim 1, wherein the input device has a positive refractive power and defines a rear focal plane, and the output device has a positive refractive power and defines a front focal plane, which essentially coincides in a focal region with the rear focal plane of the input device.

23. The polarizer device as claimed in claim 22, wherein the polarization influencing device is arranged outside the focal region.

24. The polarizer device as claimed in claim 23, wherein the polarization influencing device is arranged in the optical path upstream of the focal region.

25. The polarizer device as claimed in claim 23, wherein an aperture is provided in the focal region.

26. The polarizer device as claimed in claim 1, wherein the input device is designed so that the first light beam striking the polarization influencing device has an essentially spherical wavefront.

27. The polarizer device as claimed in claim 1, wherein the input device contains at least one aspherical surface, and is designed so that the first light beam striking the polarization influencing device has an aspherical wavefront.

28. The polarizer device as claimed in claim 1, wherein the input device and the output device respectively contain at least one cylindrical lens.

29. The polarizer device as claimed in claim 1, wherein the input device and the output device respectively contain at least one rotationally symmetric asphere.

30. The polarizer device as claimed in claim 1, further comprising a manipulation device for moving the polarization influencing device relative to the input device and the output device.

31. The polarizer device as claimed in claim 30, wherein the manipulation device is designed so that the polarization influencing device can be tilted in relation to the optical axis, about a tilting axis which extends transversely to the optical axis.

32. The polarizer device as claimed in claim 30, wherein the manipulation device is designed so that the polarization influencing device can be displaced along the optical axis.

33. The polarizer device as claimed in claim 30, wherein the manipulation device is designed so that the polarization influencing device can be displaced transversely with respect to the optical axis.

34. The polarizer device as claimed in claim 30, wherein the manipulation device is designed so that the polarization influencing device can be rotated about a rotation axis extending parallel to the optical axis.

35. The polarizer device as claimed in claim 30, wherein the manipulation device comprises a changer device, which is designed so that the polarization influencing device can be inserted selectively into the optical path between the input device and the output device, or can be removed from the optical path.

36. The polarizer device as claimed in claim 1, wherein the polarization influencing device is used in transmission, so that the polarization distribution of the exit light beam is determined by the properties of the transmitted radiation.

37. The polarizer device as claimed in claim 1, wherein the polarization influencing device is used in reflection, so that the polarization distribution of the exit light beam is determined by the properties of the reflected radiation.

38. The polarizer device as claimed in claim 1, wherein the polarizer device is provided with at least one further polarization influencing device for modifying the polarization distribution.

39. The polarizer device as claimed in claim 38, wherein the further polarization influencing device is a polarization rotator.

40. The polarizer device as claimed in claim 39, wherein the polarization rotator is designed for a rotation of polarization states through 90°.

41. The polarizer device as claimed in claim 39, wherein a plate of an optically active material is provided as the polarization rotator, which is inserted or can be inserted behind the polarization influencing device in the beam path.

42. An illumination system for a microlithography projection exposure apparatus for illuminating an illumination field with the light from a primary light source, wherein a polarizer device as claimed in claim 1 is arranged between the light source and the illumination field.

43. An illumination system for a microlithography projection exposure apparatus for illuminating an illumination field with the light from a primary light source, comprising:
a pupil shaping unit for receiving light from the primary light source and for generating a two-dimensional intensity distribution in a pupil shaping surface of the illumination system;
an angle varying input device for receiving an entry light beam coming from the pupil shaping surface and for generating a first light beam with a predeterminable first angular distribution of light rays;
an angle-selectively active polarization influencing device for receiving the first light beam and for converting the first light beam into a second light beam according to a defined angle function of the polarization state variation; and
an angle varying output device for receiving the second light beam and for generating an exit light beam traveling to the illumination field with a second angular distribution from the second light beam.

44. The illumination system as claimed in claim 43, wherein the input device comprises a light mixing device for mixing and homogenizing the light in a field surface of the illumination system, which follows the light mixing device, and the polarization influencing device is arranged in the vicinity of this field surface.

45. The illumination system as claimed in claim 44, wherein the light mixing device comprises a rod integrator with a light entry surface and a light exit surface, and the polarization influencing device comprises a polarizing layer which is arranged on the light exit surface.

46. The illumination system as claimed in claim 43, wherein the polarization influencing device comprises at least one polarizing layer, which is arranged on a layer carrying substrate.

47. The illumination system as claimed in claim 43, wherein the polarization influencing device comprises a plane plate of a transparent material, in which a polarizing layer is applied on at least one plate surface.

48. The illumination system as claimed in claim 46 wherein the polarizing layer is designed as a polarization beam splitter layer.

49. The illumination system as claimed in claim 43, wherein the polarization influencing device is interchangeable.

50. The illumination system as claimed in claim 44 wherein the light mixing device comprises at least one fly's eye condenser.
